(19) United States
(12) Patent Application Publication
(10) Pub. No.: US 2017/0326026 A1
(43) Pub. Date: Nov. 16, 2017

(54) APPARATUS FOR A PORTABLE HEAT AND STEAM CONTAINMENT SYSTEM

(71) Applicant: Michael John Kasbohm, Eden Prairie, MN (US)

(72) Inventor: Michael John Kasbohm, Eden Prairie, MN (US)

(21) Appl. No.: 15/154,037

(22) Filed: May 13, 2016

(51) Int. Cl. A61H 33/06; A61H 33/00; A47K 3/28

(52) U.S. Cl. CPC A61H 33/066; A61H 33/60; A47K 3/281; A61H 2033/068

(57) ABSTRACT

An apparatus for converting a shower space into a steam shower space, by utilizing the existing hot water supply from the existing shower head and providing a means to contain and disperse the heat and steam with-in the containment apparatus. The apparatus for creating a steam shower space generally includes a removable and portable water resistant containment curtain for containing heat and steam, a diverter that alters the direction of hot water from the shower head while dispersing heat and affecting the flow of water vapor and hot air, a frame that supports the containment curtain, and mounts that secure th.e aforementioned to the shower space structure.

### CROSS REFERENCE TO RELATED APPLICATIONS

This application is an application for a patent which is also disclosed in Provisional Application No. 62/161,836, filed on May 14, 2015 by the same inventor, namely Michael John Kasbohm, and entitled “Heat and Steam Containment Mechism for Showers,” the benefit of the filing date of which is hereby claimed, and the contents of which are incorporated herein by reference thereto.

### BACKGROUND OF INVENTION

The present invention relates generally to portable steam shower systems, and more specifically to a portable heat and steam containment apparatus for converting a standard shower, designed with relatively light weight water resistant materials, and which is removable from its mounting surface and portable so as to provide an easy way to set up in or remove from a shower space. This portable heat and steam containment apparatus is designed with materials easily adapted to fit and mount to shower space structures and provide a means to disperse and contain the transferred heat and steam from hot water flowing from the existing shower head and hot water source efficiently in the containment space thereby increasing to and maintaining typical steam shower operating temperature range with-in the containment space without the need for a dedicated steam generating apparatus.

It can be appreciated that steam rooms of various constructions in general, have been in use for many years. Traditionally, steam rooms have been designed and installed as permanent rooms separate from shower spaces and were comprised of various heavy and ridged construction materials with interiors finished with moisture resistant materials such as porcelain tile, combined with a dedicated steam generating apparatus requiring additional plumbing and electricity to superheat the water, installed by those with special skills or trades and were large enough to accommodate several people at the same time, often found in public exercise or spa facilities. In recent years smaller self-contained steam shower systems, made of relatively heavy mass produced materials prefabricated as stalls with built-in dedicated steam generators, designed to replace a standard shower stall, or displace living space as a self-contained unit, have become a growing trend for outfitting residential homes. The main problem with the traditional steam room and the newer prefabricated steam shower systems which are generally smaller than the traditional steam room, is that they are relatively expensive and generally designed to be permanent spaces once installed, and are not made to be removably mounted for convenient and easy portable access or storage. Another problem with the traditional steam room and the newer prefabricated steam shower systems is that they require an electrical source to power the dedicated steam generator and professional trades such as an electrician and or plumber to be properly and safely installed. While these devices may be suitable for the particular purpose to which they address, they are not as suitable for providing an inexpensive, easily installed, adaptable, light weight, portable, removable, and convenient means to enjoy a steam shower experience that does not require a dedicated steam generating apparatus, or additional plumbing and electricity, or special skills or trades to install.

There are known free-standing devices which are capable of being portable and made of more flexible material. However, these devices are not designed to fit in existing shower spaces or to utilize the hot water flowing from the shower head supplied by the existing central water heating system to generate heat and steam. They rely on a separate dedicated steam generator powered by electricity or other means to superheat water separate from or in addition to the existing central water heater.

Other know prior art devices do provide means for containing heat and steam, but fail to utilize the existing central water heater as the source for adequately heating the water and shower head for emitting it. They generally require expensive materials and often construction to support the installation of the system along with a separate source of electricity for the dedicated apparatus to generate heat and steam making the system as a whole relatively expensive and often displacing living space. Consequently, it is apparent that there is a distinct need in the industry for a portable heat and steam containment system which is constructed of relatively inexpensive, lightweight, water resistant material, and readily removable from its mounting surface to facilitate the ease of portability, the main containment portion designed to easily adapt to fit and mount in any existing shower space to convert all or a portion of that space to a confined structure that is substantially enclosed, and provide a means to alter the direction, divert, disperse, and contain the transferred heat and steam from hot water flowing to and emitted from the existing shower head that has been supplied by the standard central water heater that already exists in virtually all modern residences.

In this respect, the portable heat and steam containment apparatus described and claimed herein, substantially departs from the conventional concepts and designs of the prior art, and in so doing, provides an apparatus developed for the purpose of meeting the above objectives, and for providing a relatively lightweight, portable, removable, and convenient means to convert a shower space to one which is confined to a substantially enclosed area in which the user can enjoy a steam shower experience without the need for a separate dedicated steam generating apparatus or electricity or special skills or trades to install, by utilizing the hot water emitted from the existing shower head and containing it the enclosed shower space.

### BRIEF SUMMARY OF THE INVENTION

In view of the foregoing disadvantages inherent in the known types of steam rooms now present in the prior art, the present invention provides a uniquely constructed, novel heat and steam containment apparatus designed to convert a shower space with lightweight water resistant materials, is readily removable and portable, and easily adapted to fit and mount in any shower space structure confining the space or a portion thereof to a substantially enclosed containment area, and provides a means to alter the direction of flow of heated water emitted from the existing shower head and contain the transferred heat and steam with-in the containment area, thus providing the user a portable and convenient steam room experience.

To attain this, the invention comprises generally a shower structure defining confines of a shower space, a shower head configured to supply heated water to the confines of the shower space, a shower space converter configured to enclose at least a portion of the confines of the shower space, and a shower head diverter for altering the direction of flow of heated water emitted from the shower head. In one preferred embodiment, the shower space converter is comprised of a 5-paneled containment curtain or is said to have five walls or sides constructed of light weight water resistant material similar to shower curtains and preferably non-toxic, the first being the ceiling wall, and the other four walls being vertical walls which contact and conform to the shower space floor, in effect joining the containment curtain walls and the shower floor confining the area on all six sides to substantially enclose that portion of the shower space, and a zipper or other method to easily open and close a vertical seam in one of the containment curtain walls for access. In one preferred embodiment, a shower head diverter comprised of material similar to that of the containment curtain is disposed with-in the containment area to alter the direction of hot water emitted from the existing shower head aside, also helping to transfer heat and affect the flow of heated water, heated water vapor, and to augment flow and the entrainment of heated air and water vapor through one or more holes or perforations in the diverter. In one such embodiment, the containment curtain's shape is determined by conforming to a relatively rigid frame which also provides a means to suspend the containment curtain once hung in frame mounts. In one preferred embodiment the frame mounts would have two opposite sides, with the first having a frame receiving opening shaped to optimally support and constrain the frame, and the second comprised of a flat surface to mount with removable adhesive or otherwise to one or more of the shower space surfaces. In one preferred embodiment, a modified showerhead with an optimal number of mist nozzles that have been optimized for droplet size, that in combination more efficiently aid in the transference of heat from hot water flowing through and emitting from the showerhead to the surrounding air and water vapor.

In another embodiment, a relatively rigid frame may have one or more supporting poles connected to and spanning from the curtain frame the length to the shower floor as a means to support said frame. It is contemplated that one or a plurality of such supporting poles, in combination with or without frame mounts, can be utilized to support and suspend the frame and containment curtain at the preferred height.

One object of the portable heat and steam containment apparatus described and claimed herein is to provide an apparatus which utilizes at least one containment curtain panel constructed with water resistant materials that are relatively light weight and generally designed to easily adapt to fit in shower space structures to substantially enclose a portion of the shower space to contain heat and steam, and is readily removable and portable, and when in combination with the hot water emitted from the existing showerhead creates a steam shower experience of elevated temperature and heated water vapor contained within the enclosed space.

Another object is to provide a portable heat and steam containment apparatus that when combined with an existing shower space structure provides the means to form a substantially enclosed space that will adequately contain the heat and steam emitted from the existing showerhead to create a steam shower experience with-in said enclosed space.

Still another object is to provide a portable heat and steam containment system that provides for wall panels that when in contact with the shower structure surfaces, conform to said surfaces, the contact area of the surfaces forming a seal so that any open areas of the shower structure space are filled creating a substantially enclosed heat and steam containment space.

Yet another object is to provide a portable heat and steam containment apparatus that has a diverter disposed with-in said containment apparatus attached to at least one of either a containment surface panel or frame, or the shower head or neck itself, to alter the direction of hot water flowing, spraying, or dripping from the shower head and to optimally divert the water flow aside with-in the containment area down to the shower floor and drain.

It is another object of the present invention to provide a portable heat and steam containment apparatus that has a diverter disposed with-in said containment apparatus attached to at least one of either a containment curtain panel surface or frame to optimally transfer heat from hot water and disperse steam and heated air flow with-in the containment area.

It is another object of the present invention to provide a portable heat and steam containment apparatus that has a diverter disposed with-in said containment apparatus attached to at least one of either a containment curtain panel surface or frame that diverter has a hole or perforations which allow hot water, heated air and water vapor to flow through the opening or perforations to optimally transfer heat from hot water and disperse steam and heated air flow with-in the containment area.

Another object is to provide a portable heat and steam containment apparatus that incorporates a zipper or other method to easily open and close a vertical seam in one of a containment curtain wall panels for access.

Still another object yet is to provide a portable heat and steam containment apparatus that utilizes a relatively rigid frame which supports the shape of the containment curtain and also provides a means to suspend said containment curtain.

Another object of the present invention to provide a portable heat and steam containment apparatus that provides frame mounts that removably support and constrain the curtain frame, containment curtain, and diverter, suspended at the optimal height from one or more shower surfaces.

Another object of the present invention to provide a portable heat and steam containment apparatus that provides a means for displaying visible indicia, colors, or patterns.

Another object of the present invention to provide a portable heat and steam containment apparatus that provides a means to dispose protective compartments for holding low voltage electronic signaling devices such as digital thermometer, lights, audio, for emitting aroma or ozone, or smart phone, or other devices to enhance the experience.

Other objects and advantages of the present invention will become apparent to the reader throughout the detailed discussion of the invention, and it is intended for these objects and advantages to be within the scope of the present invention. To the accomplishment of the above and related objects, the portable heat and steam containment apparatus described and claimed herein may be embodied in the form illustrated in the accompanying drawings, attention being called to the fact, however, that the drawings are illustrative only, and that changes may be made in the specific construction illustrated and described without departing from the scope of invention claimed herein. Also, it is to be understood that the phraseology and terminology employed herein are for the purpose of the description and should not be regarded as limiting.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a perspective view of one preferred embodiment of a portable heat and steam containment system embodying the principles of the present invention;

FIG. 1 is an exterior perspective view of the containment curtain of the present invention;

FIG. 2 is a perspective view of an assembled frame and frame mounts of the present invention;

FIG. 3 is a back side view of the shower head diverter of the present invention;

FIG. 4 is a back side view of the shower head diverter in relationship to a section view of the containment curtain of the present invention;

FIG. 5 is a section view of the shower head diverter and containment curtain of the present invention;

FIG. 6 is a front view of a mount used to removably mount the frame of the present invention;

FIG. 7 is a section view of a mount of the present invention;

FIG. 8 is a back side view of a mount of the present invention;

FIG. 9 is an exploded section view of a mount of the present invention;

### DETAILED DESCRIPTION OF THE INVENTION

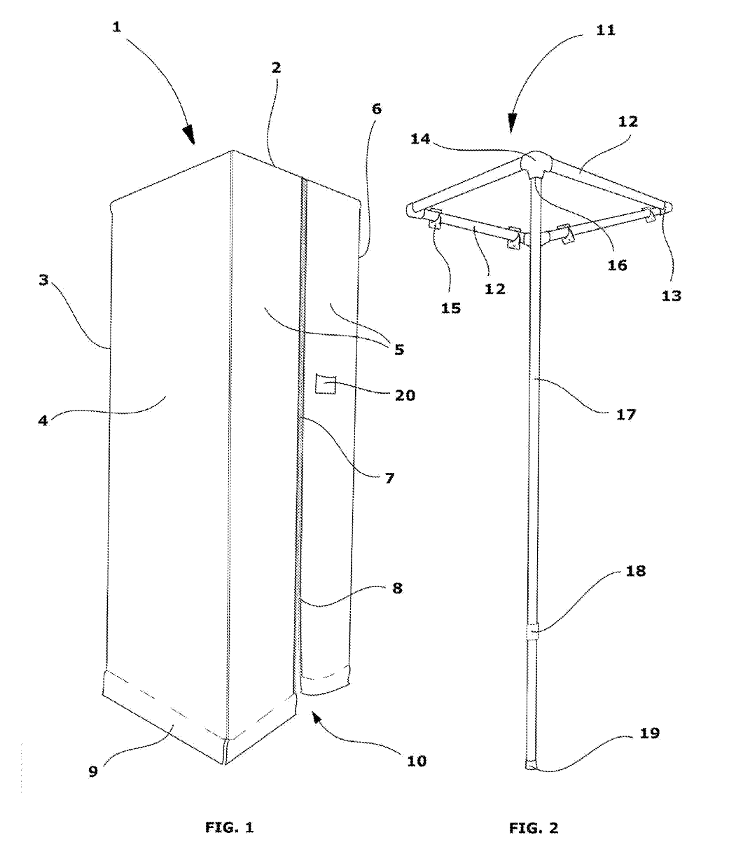

With reference being made to FIG. 1 of the drawings, a portable heat and steam containment apparatus 1 is constructed in accordance with the present invention is disclosed. As shown, the containment curtain 1 conforms to and is defined in shape and supported at the desired height by the curtain frame 11 of FIG. 2, and said frame is secured and removably mounted to the existing shower space structure with a plurality of mounts 15. A shower head diverter as shown on FIGS. 3, 4, and 5 for altering the direction of flow of heated water emitted from the shower head is connected to one of either a wall of the containment curtain or frame section and is removably secured to an opposing wall of the containment curtain. Although various alternative embodiments are contemplated, the portable heat and steam containment apparatus 1 in each includes a lightweight water resistant containment curtain 1 which functions to contain heat and steam in a shower space by substantially enclosing a shower space utilizing one or more surfaces of said shower space in which the apparatus is used, and a diverter for altering the direction of flow of heated water emitted from the shower head.

### Overview

Turning now more descriptively to the drawings, in which similar reference characters denote similar elements throughout the several views, the figures illustrate a water resistant containment curtain for containing heat and steam, a diverter that alters the direction of hot water flowing from shower head aside while also dispersing heat and affecting the flow of water vapor and heated air, a frame that supports the containment curtain and diverter, and frame mounts that secure the aforementioned to one or more of the shower space structure surfaces.

### Containment Curtain

The containment curtain in the preferred embodiment being 5-sided or is said to have five panels or walls comprised of water resistant material similar to shower curtains and preferably non-toxic, the first being the ceiling wall, and the other four walls being vertical which contact and conform to the shower floor, in effect joining the containment curtain walls and the shower space floor to substantially enclosure the area on all six sides, and a zipper to easily open and close a vertical seam in one of the containment curtain walls for access. At the time of installation, the containment curtain material is slit enough for the shower head and fixtures to penetrate through the containment curtain into the enclosed area as needed.

As shown on FIG.1, the containment curtain 1, comprised of water resistant flexible material, with a ceiling 2 and four vertical walls 3-6 creates a five-sided enclosure, the bottom portion 9 of all vertical walls contact and conform to the shower space floor substantially enclosing the area on all six sides to contain the heat and water vapor produced from the shower head. Wall 5 is split vertically top to bottom into two halves forming an access seam 7. The access seam provides an opening 10 the full height wall 5 to enter and exit that can be easily opened or secured closed with the use of a zipper 8. Moving to FIG. 5, the shower head 13 and water valve fixture 15 penetrate through the containment curtain by way of a vertical slit cut in the containment curtain as needed. Slit 12 for the shower head 13, and slit 14 for the water valve fixture 15 as needed during installation to accommodate the exact location of the shower head and water valve fixture. Back to FIG. 1, the containment curtain 1 could also incorporate a number of device compartments or pockets 20 to hold and keep dry electronic signaling devices such as a digital thermometer, lighting, audio, or other low voltage devices such as a smart phone. The device compartment 20 shown as a simple pocket mounted to the outside surface of the containment curtain 1 when containment curtain material is relatively clear.

While the containment curtain and frame optimally creates an enclosure with a footprint that is square or rectangular for adapting to most shower or bathtub spaces, it has been contemplated that other shapes such as circular or elliptical or other geometric or more organic shapes could easily be incorporated into the design. While adequate ventilation is provided by the penetrations through the containment curtain, and at points where wall panels are not completely joined such as at the corners where bottom of the wall panels 9 meet, it has been considered that additional grommets or ventilation holes could be added to the containment curtain or panel to provide additional ventilation. The containment curtain material could be fabricated with more rigid walls, with or without a frame and or with any relatively lightweight water resistant material. In any case the containment curtain or panel thereof could be printed with different colors, patterns or indicia. If the material is flexible, one or a plurality of the walls could be pleated providing extra material for expanding the interior space beyond the normal footprint. The containment curtain could have multiple layers for better insulating qualities to better contain heat. The access seam could be secured closed with any number of mechanical couplings or pressure release mechanism such as magnets, hook and loop, button, or snapping, or suction cup. More than one seam could be incorporated into the containment curtain, whether in a vertical wall or in a corner where the walls meet.

### Frame

On FIG. 2 the frame 11 shown provides for a relatively rigid structure to support the containment curtain. It is appreciated that the frame could be made from a variety of water resistant materials and shapes. As shown, the frame 11 is comprised of four round elongated tubes 12 having a first end and a second end, both ends being of the same shape and size, connected together in a square or rectangular shape by inserting into four in total 90-degree elbows, three of which said elbows have two openings 13 and one of which has three openings 14, one 90-degree elbow set between each frame section, each end of the frame section inserts into the similarly shaped dimensionally minimally larger opening of one end of 90-degree elbows on the same plane which have two said openings orientated outwardly 90 degrees from the corner point of the elbow, and the fourth 90-degree elbow 14 with its first two openings having the same orientation of two openings on the same plane as the two-opening elbows, and which also has a third opening 16 orientated downward and perpendicular to the other openings for receiving a support pole 17, together the four elongated tubes and four 90-degree elbows forming a square or rectangular shaped frame on the same horizontal plane, with a vertical support pole extending down from the frame the length to the shower space floor.

The Curtain Frame 11 is comprised four round elongated plastic tubes 12, three two-openings 90-degree elbow joiner parts 13, one three-openings 90-degree elbow joiner part 14, one support pole 17, one support pole coupling 18 to alter the length of support pole 17, and one support pole anti-slip end cap 19. Once assembled the frame 11 provides a structure for the containment curtain. It has been contemplating that the frame sections could be an elongated square or rectangular shaped with similarly shaped openings in the 90-degree elbow joiners, or the frame could be one continuous organic shape, or the containment curtain itself could be more rigid in which case it would also function as the frame. The supporting pole could be a single piece, telescoping, or multiple pieces that join together. The frame or a portion thereof could be suspended from the shower structure ceiling and or other shower structure surfaces.

### Mounts

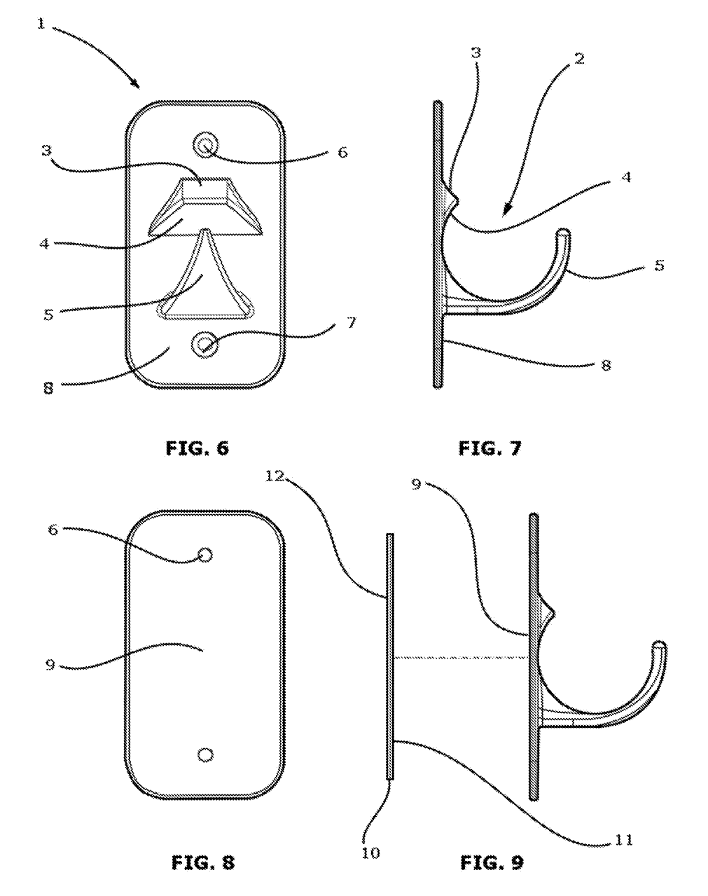

FIG. 6 is a front view of a mount 1 used to secure a round elongated tube frame section to one or more surfaces a shower space structure. The mounts have a front side 8, and a back side 9 as shown on FIG. 8. The back side could be joined to a shower space structure surface with any number of wall fastener types, but optimally with a double-sided water resistant removable adhesive tape 10 of FIG. 9 disposed on the back side of the mount 9 by way of side 11 of the tape 10, and then to a wall surface by way of the exposed adhesive side of the tape 12, for quick and easy installation that does not require tools and does not necessitate penetration of the shower space surface. Once fastened to the shower space surface, the front side of the mounts hold the frame perpendicular to the shower space wall surface or surfaces at the optimum height. The front portion of the mounts have a receiving area 2 shown on FIG. 7 shaped to form a cavity to removably receive and secure the tube frame sections by way of a beveled leading receiving edge 3, a back side beveled edge 4 and a resiliently biasly apposed extended portion 5, together forming a semi-circular shaped cavity 2 to retain an elongated circular tube frame section 12 of FIG. 2. By way of example with specific reference to FIGS. 2, 6, and 7, the round frame 12 section will be guided by leading beveled edge 3 and then engage with the extended portion 5 such that upon application of force, the resiliently biased extended portion 5 will give way outwardly allowing the frame 12 section to pass through the opening 2 and come to rest in the semi-cylindrical receiving portion of the mount. The mounts may have pilot holes 6 as shown on FIG. 6 with beveled leading edges 7 forming a countersink for optional mounting methods utilizing a screw or bolt.

Any number of shapes of mounts could be used to receive varying shaped frame sections and elbow joiners. In an alternately square shaped elongated frame section and similarly shaped openings in the 90-degree elbow joiners, the receiving area cavity of the mounts would also be square shaped to further secure the frame by constraining it from twisting with-in the mount, the result being that when the assembled the frame sections are secured in the mounts, the combination would have a cantilever effect to frame sections not mounted to a shower surface to resist sagging. Other mount shapes could take on more aesthetic and decorative considerations. The mounts could be simple snaps, other pressure release mechanisms, or mechanical couplings. Likewise the materials used for the containment panel or panels is limited only to that which is able to be made relatively lightweight and impervious to wet conditions and are preferably non-toxic.

### Diverter

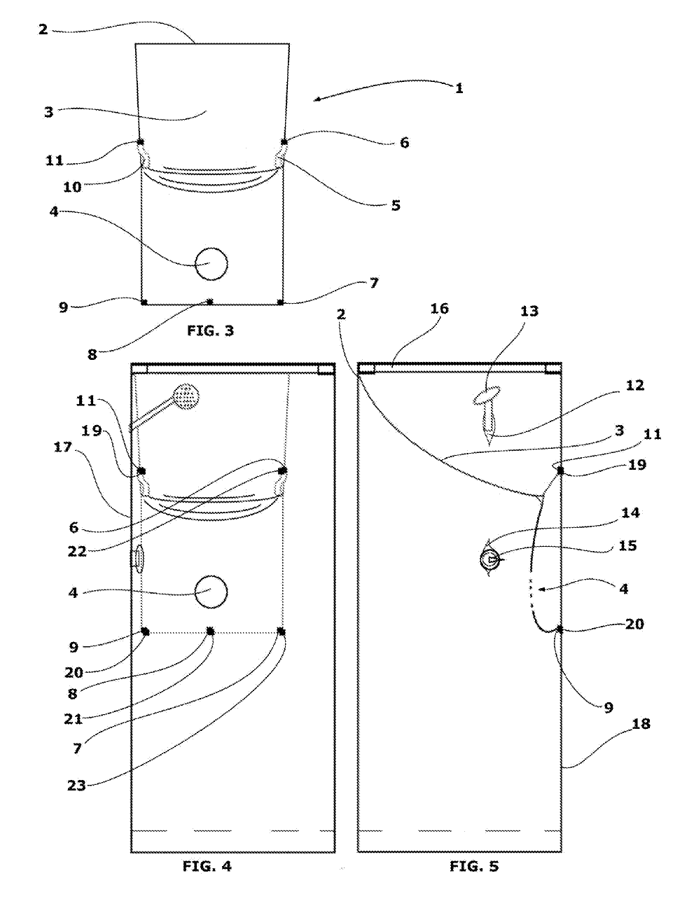

Moving to FIG. 3, which is a back side view of the diverter 1 is constructed of the same or similar material as the containment curtain and is secured along its top edge 2 to the top of one of either the containment curtain walls or frame sections. It has two has two straps 5 and 10 with magnets 6 and 11 respectively, secured at the end of said straps and used to removably connect to the containment curtain wall on the opposing side witch also has magnets or a metallic surface at the upper mounting points 19 and 22 as shown on FIG. 4. There are also three mounting point magnets at the bottom end of the diverter denoted by 7, 8, and 9 shown on FIG. 3 and FIG. 4 which are directly adhered to the diverter, and which are used to connect to three lower mounting points on the opposing wall of the containment curtain 20, 21, and 23. The diverter 1 also has a circular shaped hole or penetration 4 which allows a heated air and water vapor to flow through the opening. Relative to FIG. 4 we see a back view of the diverter in combination with a section view of the containment curtain and frame, and in this illustration the containment curtain material being semi-opaque, and we see the orientation of the diverter and its attachments to the containment curtain. In FIG. 5 we see a section view of the diverter 3 and the containment curtain 18 with the diverted attached in place to two of its removable mounting points upper 19 and lower 20. We also see the shower head 13 shown penetrating the containment curtain through slit opening 12 and water valve fixture 15 penetrating through slit opening 14. The top edge of the diverter 2 is fixed to either the containment curtain or frame at 2, and the diverter is draped under the shower head over to the opposing containment curtain wall and connects with the two mounting straps 5 and 10 shown in FIG. 3 by way of its attached magnets 6 and 11 to the releasable contact points 19 and 22 as shown on FIG. 4 as magnets or a metallic surfaces. We also see the lower connecting magnet 9 removably connected to the connecting point magnet or metallic surface 20. The magnets are used so the connections are easily removable and so that the diverter can be moved aside out of the way when utilizing the space as a normal shower. When in use, the diverter alters the direction of the hot water spray, flow, or dripping from the shower head, over to the opposing wall 18 as shown on FIG. 5 and down the same wall to the floor drain. The magnets also provide a means to easily make adjustments in orientation of the diverter contact points to the containment curtain wall connecting points. These slight adjustments at the connection points of the diverter to the containment curtain wall further alter the direction and path of the flow of heated water, heated water vapor, and heated air and how it circulates throughout the containment area, and through the penetration hole 4. How the heated water, heated water vapor, and heated air flows, is affected by a number of factors such as the temperature of the water emitting from the shower head, the volume and pressure of the water flowing to and from the shower head, and the pattern of spray emitting from the shower head nozzles. Any variation of these and other factors will affect heat transfer and the flow of the heated water vapor. Once the user has adjusted the factors above, the user can then further affect the vapor and hot air flow by adjusting the orientation of the diverter connecting points. While the diverter is shown with a single continuous length of material, it is understood that variations in its construction could be incorporated. One such variation could be a vertical portion added to further block spray. The diverter could be a panel or panels of more rigid material. The diverter could be attached to or an attachment to the shower head or neck rather than the containment curtain or frame. Other variations could incorporate multiple perforations or textured patterns in the lower portion of the diverter to further disperse and optimize the heat transfer and water vapor flow. The diverter could also incorporate a means to contain and dispense various substances for aroma therapy. It is also recognized that a modified shower head with an optimal number of nozzles that form a droplet size more conducive to heat transfer from said droplets to the surrounding air and water vapor, in combination with the invention, will enhance the efficiency of the system by reducing the volume of hot water flow through the shower head required to maintain the desired internal temperature of the containment area. It has also been considered that in addition to a shower head optimized for droplet size, a means for a secondary source of heat could be added to the shower head such as electronic heating elements.

### Connections of Main Elements and Sub-Elements of the Preferred Embodiment

The containment curtain 1 of FIG. 1 drapes over the frame 11 of FIG. 2. The frame sections 12 of FIG. 2 are joined by alternately inserting the sections into the 90-degree elbows 13 and 14 by friction fit, once together forming the square or rectangular portion of the frame, and the assembled supporting pole 17 is then inserted to the bottom opening 16 of elbow 14 and frame is completed. The main section of supporting pole 17 is connected to the lower portion by the coupling 18, and the anti-slip end cap 19 is attached to the end of the supporting pole where it comes in contact to the shower floor. The assembled containment curtain and frame are then lifted and set into mounts which have been previously adhered to the shower space walls at a height above the shower head and so that the bottom of the containment curtain will remain in contact with the shower space floor once set in the mounts. A portion of the containment curtain material will be pinched between the frame and the mount opening cavity perimeter.

### Alternative Embodiments of Invention

Many variations of materials could be used to form the containment curtain. They could be more rigid materials, foldable, or modular. Likewise, the mounts could be made of any type of material suitable for wet conditions, and be made of more ornamental design for aesthetic purposes. The containment curtain could be a single panel capping a shower stall space that is otherwise enclosed, or a combination of panels attached to the shower space surface openings to complete the enclosure. The frame 11 shown in FIG. 2 could be completely supported by four poles positioned under each of the 90-degree elbows forming a table like structure rather than set in mounts. The supporting pole could be a single piece, telescoping, or multiple pieces that join together. The containment curtain and or frame could also be suspended from the shower space ceiling by way of a single ceiling mount system. The frame could be constructed so that it had optimized spray nozzles incorporated into it, the frame itself acting as the water tube supply to the nozzles, the frame supplied by a water line from a water-valve-diverter between the shower water supply and shower head. The diverter could be attached, or have an attachment to, the shower head or neck.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

1. An apparatus for converting a shower space into a heat and steam containment system, comprising:
(a) a shower structure defining confines of a shower space;
(b) a shower head configured to supply heated water to the confines of the shower space;
(c) a shower space converter configured to enclose at least a portion of the confines of the shower space; and
(d) a shower head diverter for altering the direction of flow of heated water emitted from the shower head.

2. The shower space converting apparatus of claim 1, wherein the shower space converter includes a containment curtain which is comprised of a lightweight water resistant material.

3. The shower space converting apparatus of claim 2, wherein the containment curtain includes at least one panel configured to enclose substantially the confines of the shower space.

4. The shower space converting apparatus of claim 1, wherein the shower space converter includes at least one panel configured to enclose at least a portion of the confines of the shower space.

5. The shower space converting apparatus of claim 3, wherein the shower space converter includes a removable frame which connects to the shower structure for supporting at least one panel which encloses at least a portion of the confines of the shower space.

6. The shower space converting apparatus of claim 5, wherein the shower space converter includes a removable frame with at least one pole supporting the frame.

8. The shower space converting apparatus of claim 5, wherein the shower space frame removably connects with mounts to at least a portion of the confines of the shower space.

9. The shower space converting apparatus of claim 5, wherein the shower space converter includes a removable frame which connects to the shower structure for supporting the at least one panel which encloses at least a portion of the confines of the shower space and at least one said panel is configured to provide a means for entry and exiting the enclosure.

10. The shower space converting apparatus of claim 1, wherein the shower space converter includes a shower head diverter which is comprised of a lightweight water resistant material.

11. The shower space converting apparatus of claim 10, wherein the shower head diverter and has one or more holes or perforations, or is otherwise textured.

12. The shower space converting apparatus of claim 2, wherein containment curtain provides a means to form one or more compartments.

13. The shower space converting apparatus of claim 2, wherein the containment curtain provides a means to form one or more protective compartments which may hold a low voltage electronic device.

14. The shower space converting apparatus of claim 2, wherein the containment curtain provides a means to dispense aromatic fragrances or oils.

15. An apparatus for converting a shower space into a heat and steam containment system, comprising:
(a) a shower structure defining confines of a shower space;
(b) a shower head configured to supply heated water to the confines of the shower space;
(c) a shower space converter which includes a 5-sided containment curtain which is comprised of a lightweight water resistant material; and
(d) a removable frame for supporting the containment curtain which encloses at least a portion of the confines of the shower space.
(e) a shower head diverter which is comprised of a lightweight water resistant material for altering the direction of flow of heated water emitted from the shower head.

16. The shower space converting apparatus of claim 16, wherein the shower head diverter which is comprised of a lightweight water resistant material which has one or more holes or perforations, or is otherwise textured.

17. The shower space converting apparatus of claim 16, wherein the 5-sided containment curtain of which at least one side is configured to provide a means for entry and exiting the enclosure.

18. The shower space converting apparatus of claim 16, wherein the shower space converter includes a frame which connects to the shower structure and which frame has one or a plurality of support poles.

19. The shower space converting apparatus of claim 16, wherein the shower space converter includes a free standing frame with a plurality of support poles which supports the containment curtain.

20. An apparatus for converting a shower space into a heat and steam containment system, comprising:
(a) a shower structure defining confines of a shower space;
(b) a shower head configured to supply heated water to the confines of the shower space;
(c) a shower space converter which includes a 5-sided containment curtain which is comprised of a lightweight water resistant material; and
(d) a removable frame which connects to the shower structure for supporting the shower curtain which encloses at least a portion of the confines of the shower space; and
(e) removable frame mounts for removably attaching a frame to the shower structure; and
(e) a shower head diverter which is comprised of a lightweight water resistant material for altering the direction of flow of heated water emitted from the shower head.
